(19) United States
(12) Patent Application Publication
(10) Pub. No.: US 2009/0309968 A1
(43) Pub. Date: Dec. 17, 2009

(54) Accessorizable security camera

(76) Inventor: Yi-Jen Cheng, Taichung (TW)

Correspondence Address: BACON & THOMAS, PLLC, 625 SLATERS LANE, FOURTH FLOOR, ALEXANDRIA, VA, 22314-1176, US

(21) Appl. No.: 12/213,043

(22) Filed: Jun. 13, 2008

(51) Int. Cl. H04N 7/18

(52) U.S. Cl. 348/143; 348/E07.085

(57) ABSTRACT

An accessorizable security camera has at least one functional accessory and a camera body having a case, security camera optoelectronical module, a front cap assembly and a rear cap. The case is tubular and has a front opening, a rear opening, an outer surface and at least one guiding structure. The at least one guiding structure may be a recess being formed longitudinally on the outer surface of the case. The at least one functional accessory may be a weather cover, an auxiliary light source, an auxiliary mounting bracket, a motion sensor, a combination thereof or the like. The at least one functional accessory has a mounting structure corresponding to the guiding structure and being selectively and detachably mounted in the guiding structure. Therefore, the at least one functional accessory may be easily mounted on the camera body by using the mounting structure to increase flexibility of use.

### BACKGROUND OF THE INVENTION

1. Field of Invention

The present invention relates to security camera, and more particularly to an accessorizable security camera that is capable of having different functional accessories easily mounted thereon.

2. Description of the Related Art

Security cameras are very commonly used in security monitoring. For different installation environments, kinds of security cameras with different accessories are used to improve function depending on environmental and use factors. The accessories may comprise auxiliary light sources, weather resistant caps, infrared light sources, infrared detectors or the like. However security cameras are purchased integrated with such accessories, so should one accessory be required after installation, replacement of the security camera is required at great cost.

With reference to FIG. 6, security cameras commonly need auxiliary light sources for night recording. An auxiliary light security camera comprises a case (91), an optoelectronical module (92), a light source assembly (93) and a transmittance front cap (911). The case (91) is cylindrical and has an opening. The optoelectronical module (92) is securely mounted coaxially in the case (91) and has a camera lens being centrally mounted toward the opening of the case (91). The light source assembly (93) is a light emitting diode array and is mounted inside the case (91) around the camera lens of the optoelectronical module (92). The transmittance front cap (911) is mounted securely over the opening of the case (91) to prevent dust and weather affecting the security camera to improve operational life span. However, a contrast ratio (CR) of images recorded by the security camera is reduced significantly by reflection from the transmittance front cap (911) when the light source assembly (93) is turned on, this problem is more serious when transmittance front cap (911) is dirty.

With reference to FIGS. 7 and 8, to prevent CR problems of the conventional security camera, a security camera with external light source is provided, where the security camera comprises a camera body (95) and an external light source (97) being mounted thereon. The external light source (97) provides lights for the camera body (95) when performing night recording without unnecessary interference by reflected light. However, the external light source (97) prevents disassembly and adjustment of the external light source (97) relative to the camera body (95) during installation or maintenance. The security camera with external light source may have installation problems since the external light source easily interferes with walls when the security camera is installed in a corner. Therefore, places for installing the security camera with external light source are limited. Furthermore, the security camera with external light source is larger and aesthetically less pleasing. The external light source (97) may also be subject to damage.

The present invention provides an accessorizable security camera to mitigate or obviate the shortcomings of the aforementioned problems.

### SUMMARY OF THE INVENTION

The primary objective of the present invention is to provide an accessorizable security camera to improve flexibility of the security camera by allowing installation and removal of different functional accessories.

The accessorizable security camera has at least one functional accessory and a camera body having a case, security camera optoelectronical module, a front cap assembly and a rear cap. The case is tubular and has a front opening, a rear opening, an outer surface and at least one guiding structure. The at least one guiding structure may be a recess being formed longitudinally on the outer surface of the case. The at least one functional accessory may be a weather cover, an auxiliary light source, an auxiliary mounting bracket, a motion sensor, a combination thereof or the like. The at least one functional accessory has a mounting structure corresponding to the guiding structure and being selectively and detachably mounted in the guiding structure. Therefore, the functional accessories may be easily mounted on the camera body using the mounting structure to increase flexibility of use.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an accessorizable security camera in accordance with the present invention;

FIG. 2 is an exploded perspective view of the accessorizable security camera in FIG. 1;

FIG. 3 is a perspective view of a first embodiment of the accessorizable security camera in accordance with the present invention;

FIG. 4 is a perspective view of a second embodiment of the accessorizable security camera in accordance with the present invention;

FIG. 4A to 4C are enlarged cross-sectional views showing various embodiments of a guide structure in accordance with the present invention;

FIG. 5 a perspective view of a third embodiment of the accessorizable security camera in accordance with the present invention;

FIG. 6 is a perspective view of a security camera in accordance with the prior art;

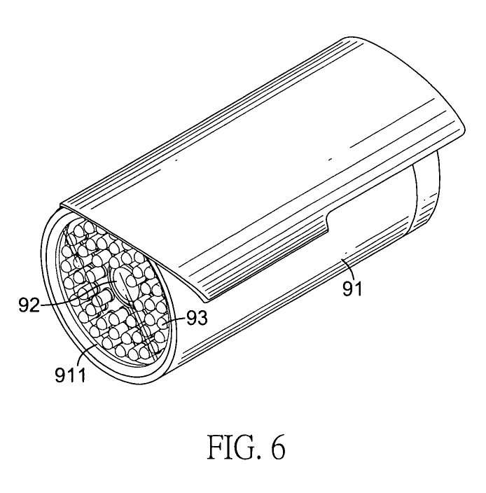

FIG. 7 is an operational perspective view of another security camera in accordance with the prior art; and

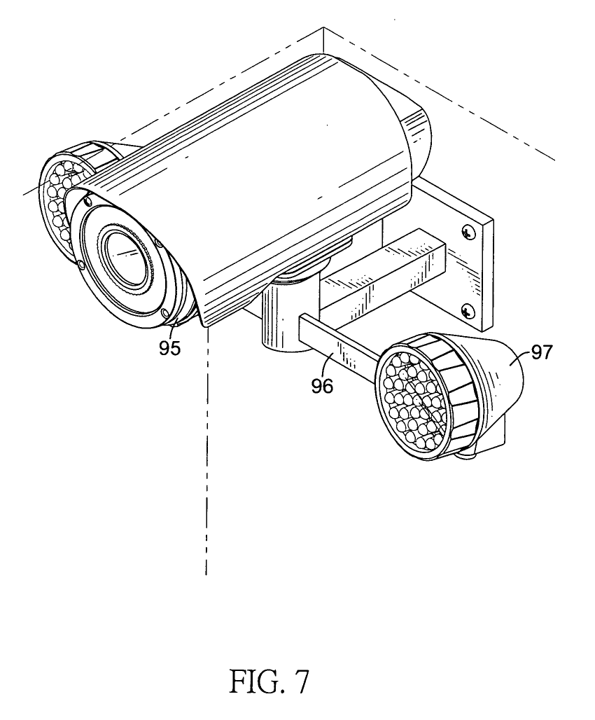

FIG. 8 is an operational top view of the security camera in FIG. 7.

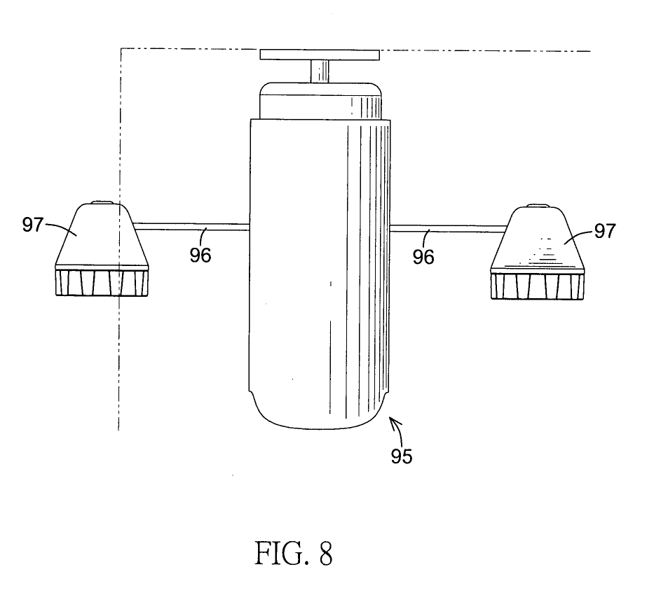

### DETAILED DESCRIPTION OF THE INVENTION

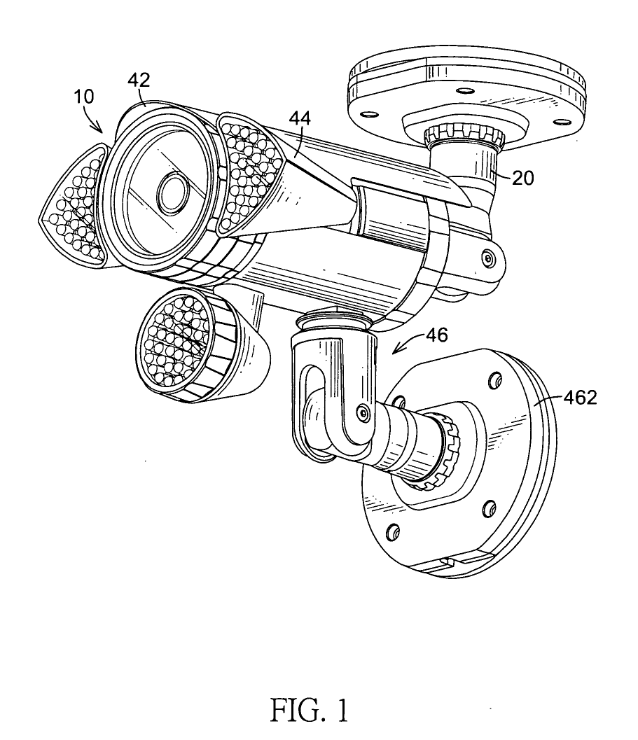

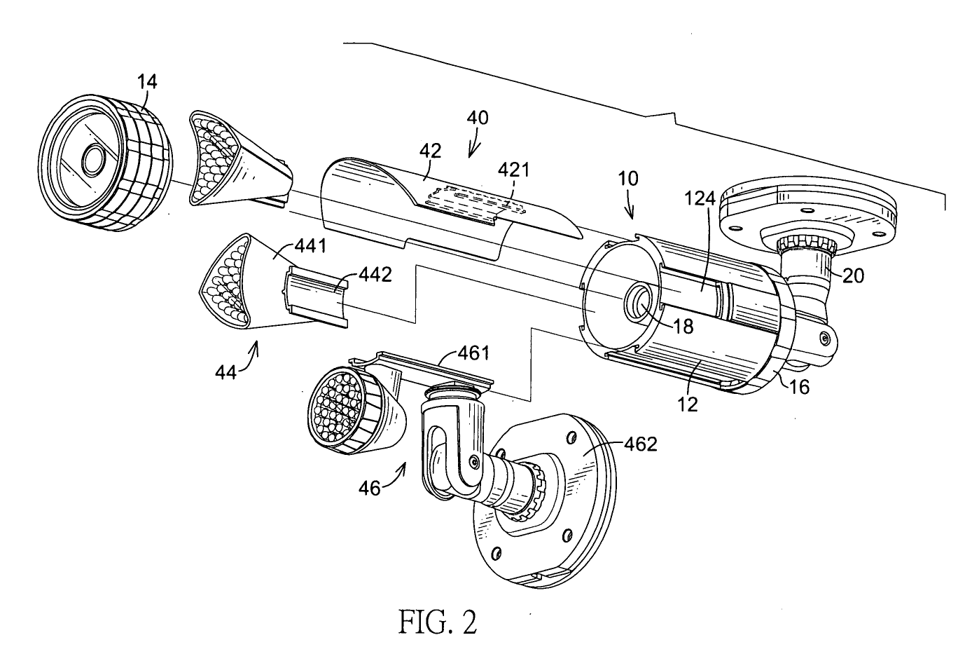

With reference to FIGS. 1, and 2, an accessorizable security camera in accordance with the present invention comprises a camera body (10), a main mounting bracket (20) and at least one functional accessory (40).

The camera body (10) has a case (12), a security camera optoelectronical module (18), a front cap assembly (14) and a rear cap (16).

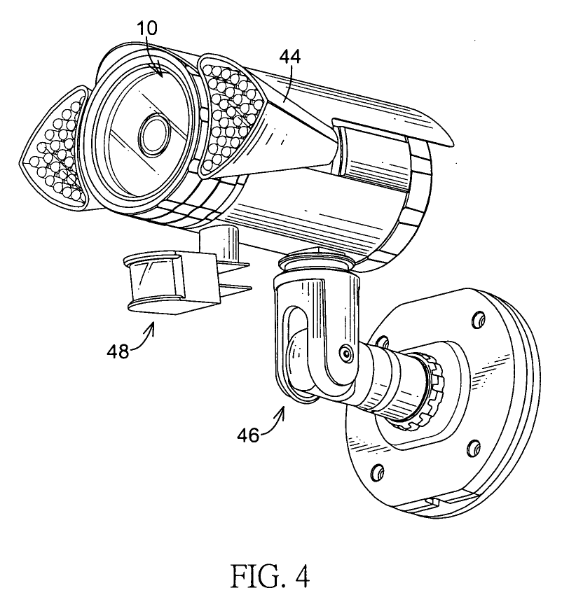

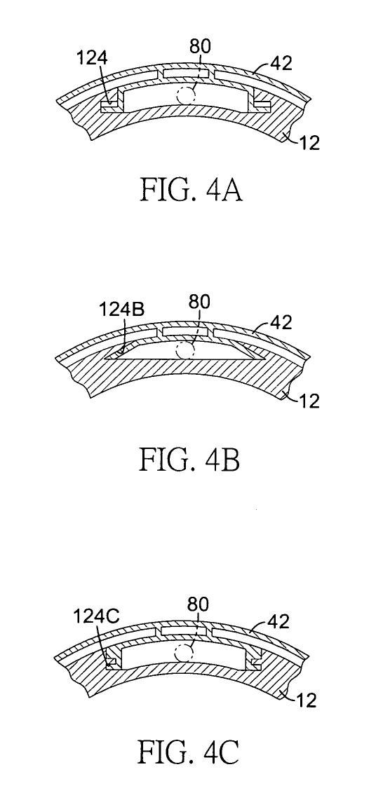

With reference to FIGS. 4A, 4B and 4C, the case (12) is tubular, may be a hollow cylinder and has an inner surface, a front opening, a rear opening, an outer surface and at least one guiding structure (124, 124B, 124C). The at least one guiding structure (124, 124B, 124C) is substantially cuboidal and is formed on the outer surface of the case (12), may be longitudinally or tangentially formed on the outer surface, may be a tab protruding form the outer surface or a recess formed in the outer surface and comprises two side walls and at least one pair of guide channels. The pair of guide channels are respectively formed on the sidewalls of the guiding structure and may be protrudent or recessed.

In a preferred embodiment of the present invention, the case (12) has four guiding structures (124). In the preferred embodiment, the guiding structures (124) are recesses parallelly and separately formed longitudinally in the outer surface of the case (12). The guide channels may be recessed in the side walls of the at least one guiding structure to form an inverted T in cross section as shown in FIG. 4 A, may be tapered recesses in the side walls of the at least one guiding structure to form an arch in cross section as shown in FIG. 4B or may be protrusions being formed on and protruding from the side walls of the at least one guiding structure as shown in FIG. 4C.

The security camera optoelectronical module (18) is capable of successively capturing light to generate an electrical video image, is mounted securely inside the case (12) and has a camera lens being disposed facing the front opening of the case (12).

The front cap assembly (14) and the rear cap (16) are detachably mounted respectively on the front opening and the rear opening of the case (12) to seal and protect the security camera optoelectronical module (18) inside the case (12).

The main mounting bracket (20) has an arm and a base. The arm of the main mounting bracket (20) is selectively and detachably attached securely to the camera body (10), may be connected to the rear cap (16) and may pivot and rotate, and may be controlled by a drive device to pivot and rotate. The base of the main mounting bracket (20) is mounted securely on the arm and is capable of being mounted on a flat surface such like a wall or a ceiling to hold the camera body (10) in an installed position.

The at least one functional accessory (40) may be a weather cover (42), an auxiliary light source (44), an auxiliary mounting bracket (46), a motion sensor (48), a combination thereof and the like. Each one of the at least one functional accessory has a mounting structure (421, 442, 461) corresponding to and being selectively and detachably mounted with the guiding structure (124, 124B, 124C). In the preferred embodiment of the present invention, the mounting structure (421, 442, 461) is a protruding tab corresponding to the guiding slot (124, 124B, 124C). In the preferred embodiment of the present invention, the mounting structures (421, 442, 461) of different functional accessories are further hollowed thereby defining a gap between the guiding structure (124, 124B, 124C) and the mounting structure (421, 442, 461). The gap between the guiding structure (124) and the mounting structure (421, 442, 461) is used for mounting cabling (80) of the functional accessory (40) to prevent damage to the cabling (80) by sun exposure, moisture or human activities including cleaning and purposely destroy.

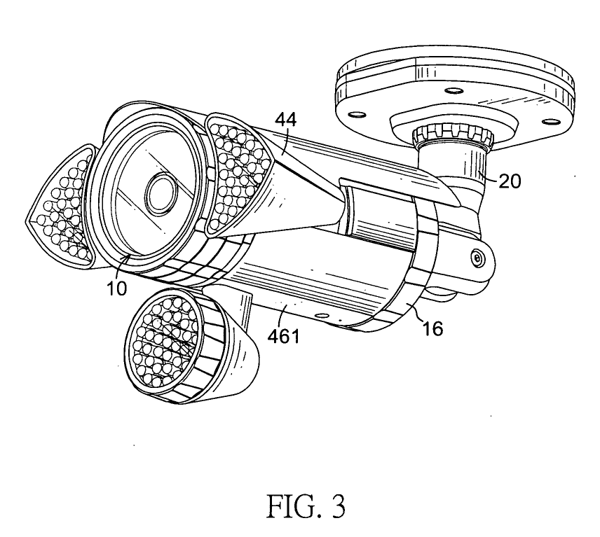

With further reference to FIGS. 3 and 4, the weather cover (42) is an arced sheet and has the mounting structure (421) protruding therefrom and is implemented to prevent weather damage and improve picture quality by preventing precipitation obscuring and dirtying the front cap assembly (14) and by shading the camera from the sun so reducing glare and contrast ratio. The weather cover (42) is selectively mounted in one of the at least one guiding structure (124) using a corresponding mounting structure (421) and is held securely on the case (12) once the front cap assembly (14) and the rear cap (16) are mounted on the case (12).

The auxiliary light source (44) comprises a light source body (441) and the mounting structure (442). The light source body (441) emits light and may be an LED array that may be independently powered, such as by a battery or solar panels or is electrically connected to the security camera optoelectronical module (18). When the light source body (441) is electrically connected to the optoelectronical module (18), cabling between the light source body (441) and the Optoelectronical module (18) may be mounted in the gap between the corresponding guiding structure (124) and the mounting structure (442). Therefore, the cabling is well protected. The mounting structure (442) of the auxiliary light source (44) is integrally formed with the light source body (441).

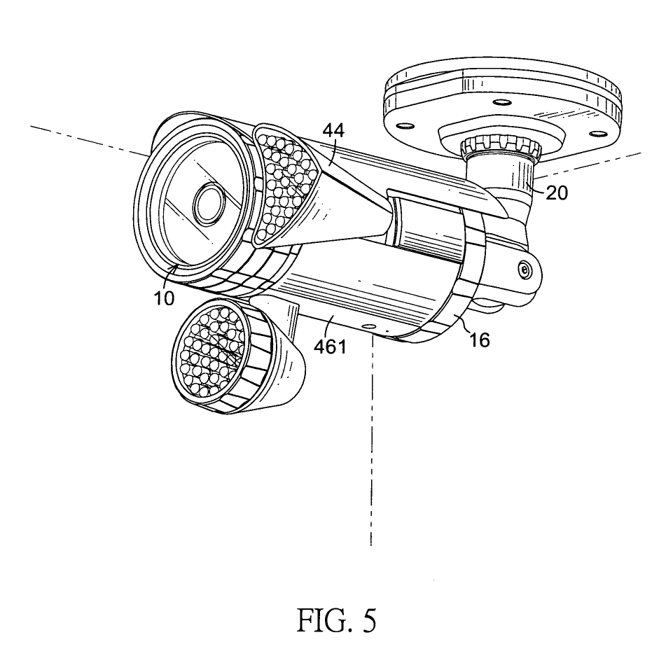

The auxiliary mounting bracket (46) has an auxiliary base, an auxiliary arm and the mounting structure (461). The mounting structure (461) is securely attached to a distal end of the auxiliary arm of the auxiliary mounting bracket (46) and may be attached by being screwed on, integrally formed on or bound on. Wherein, the auxiliary mounting bracket (46) allows quick installation on demand so allows security cameras to be moved and relocated quickly and easily for different operations, for instance at sports stadia, when match day may require cameras to be located externally to watch crowds or persons entering by entrances, but during other periods, the cameras may be required to be located internally for security. Furthermore, should the camera body (10) be located in a particularly dirty atmosphere or high risk locale and require frequently removal for cleaning or maintenance the auxiliary mounting bracket (46) may be used to mount and be easily detached from the auxiliary mounting bracket (46) by removing the front cap assembly (14). With reference to FIG. 5, the auxiliary mounting bracket (46) may also be used to test installation and be removed from the mounting structure (461) after the mounting structure (461) is mounted in one of the guiding structures (124) and attached to the main mounting bracket (20).

The motion sensor (48) is an electric device that is capable of detecting motion, may be by transmitting infrared light. The motion sensor (48) may have an independent mounting structure that is mounted therewith or may be mounted on one of the mounting structure (421, 442, 461) of another functional accessory (40). In the preferred embodiment of the present invention, the motion sensor (48) is mounted on the mounting structure (461) of the auxiliary mounting bracket (46).

In summary, the accessorizable security camera in accordance with the present invention is capable of mounting various kinds of functional accessories (40) by demand since the camera body (10) has multiple guiding structure (124) making installation easier and improving flexibility use.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. An accessorizable security camera comprising
a camera body having
a case being tubular and having
an inner surface;
a front opening;
a rear opening;
an outer surface; and
at least one guiding structure, the at least one guiding structure being cuboidal and being formed on the outer surface of the case and each one of the at least one guiding structure having two side walls and at least one pair of guide channels being respectively formed on the sidewalls of the guide structure;
a security camera optoelectronical module being capable of successively capturing light to generate an electrical video image, being mounted securely inside the case and having a camera lens being disposed facing the front opening of the case;
a front cap assembly being detachably mounted on the front opening to seal and protect the security camera optoelectronical module; and
a rear cap being detachably mounted on the rear opening of the case.

2. The accessorizable security camera as claimed in claim 1, wherein the security camera further has at least one functional accessory, each one of the at least one functional accessory has a mounting structure corresponding to and being selectively and detachably mounted with one of the at least one guiding structure.

3. The accessorizable security camera as claimed in claim 2, wherein
each one of the at least one guiding structure is a recess being formed longitudinally in the outer surface of the case; and
the mounting structure of each one of the at least one functional accessory is a protruding tab corresponding to one of the at least one guiding structure, is detachably mounted in a corresponding one of the at least one guiding structure and is hollowed thereby defining a gap between the corresponding guiding structure and the mounting structure.

4. The accessorizable security camera as claimed in claim 3, wherein the guide channels are recessed in the side walls of each one of the at least one guiding structure to form an inverted T in cross section.

5. The accessorizable security camera as claimed in claim 3, wherein the guide channels are tapered recesses in the side walls of each one of the at least one guiding structure to form an arch in cross section.

6. The accessorizable security camera as claimed in claim 3, wherein the guide channels are protrusions being formed on and protruding from the side walls of each one of the at least one guiding structure.

7. The accessorizable security camera as claimed in claim 3, wherein the security camera further has a main mounting bracket having
an arm being selectively and detachably attached securely to the rear cap; and
a base being mounted securely on the arm of the main mounting bracket.

8. The accessorizable security camera as claimed in claim 3, wherein the case has multiple guiding structures being parallelly and separately formed longitudinally in the outer surface of the case.

9. The accessorizable security camera as claimed in claim 8, wherein one of the at least one functional accessory is a weather cover being an arced sheet and having a mounting structure protruding therefrom, the weather cover is selectively mounted in one of the guiding structures by the mounting structure on the weather cover.

10. The accessorizable security camera as claimed in claim 8, wherein one of the at least one functional accessory is an auxiliary light source comprising a light source body and a mounting structure, where the mounting structure is integrally formed on the light source body and is selectively mounted in one of the guiding structures.

11. The accessorizable security camera as claimed in claim 8, wherein one of the at least one functional accessory is an auxiliary mounting bracket having
a mounting structure being mounted in one of the guiding structures;
an auxiliary arm being securely attached to the mounting structure on the auxiliary mounted bracket; and
an auxiliary base being securely mounted on the auxiliary arm.

12. The accessorizable security camera as claimed in claim 8, wherein one of the at least one functional accessory is a motion sensor comprising a mounting structure formed integrally therewith and being selectively mounted in one of the guiding structures using the mounting structure on the motion sensor.

13. The accessorizable security camera as claimed in claim 8, wherein the accessorizable security camera has multiple functional accessories, wherein
one of the functional accessories is a weather cover being an arced sheet and having a mounting structure protruding therefrom, the weather cover being selectively mounted in one of the guiding structures by the mounting structure on the weather cover;
one of the functional accessories is an auxiliary light source comprising a light source body and a mounting structure, where the mounting structure is integrally formed on the light source body and is selectively mounted in one of the guiding structures;
one of the functional accessories is an auxiliary mounting bracket having
a mounting structure being selectively and detachably mounted in one of the guiding structures;
an auxiliary arm being securely attached to the mounting structure of the auxiliary mounting bracket; and
an auxiliary base being securely mounted on the auxiliary arm; and
one of the functional accessories is a motion sensor motion sensor comprising a mounting structure formed integrally therewith and being selectively mounted in one of the guiding structures using the mounting structure on the motion sensor.

14. The accessorizable security camera as claimed in claim 13, wherein the guide channels are recessed in the side walls of each one of the guiding structures to form inverted T in cross section.

15. The accessorizable security camera as claimed in claim 13, wherein the guide channels are recessed in the side walls of each one of guiding structures to form arches in cross section.

16. The accessorizable security camera as claimed in claim 13, wherein the guide channels are protrusions being formed on and protruding from the side walls of each one of the guiding structures.
